(19) United States
(12) Patent Application Publication
(10) Pub. No.: US 2005/0191539 A1
(43) Pub. Date: Sep. 1, 2005

(54) Fuel cell

(75) Inventors: Shoji Yoshioka, Tokyo (JP); Tatsunori Okada, Tokyo (JP); Osamu Hiroi, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/911,712

(22) Filed: Aug. 5, 2004

(30) Foreign Application Priority Data
Feb. 26, 2004 (JP) 2004-051860

(51) Int. Cl. H01M 8/02; H01M 4/94

(52) U.S. Cl. 429/38; 429/39; 429/44

(57) ABSTRACT

A fuel cell that prevents gas slippage, with minimal reduction in effective area for electrode reaction. At least one of a fuel gas flow path and an oxidizing gas flow path is configured with flow channels having bends and so that gas flows between ends of the flow channels, and, among ridges between a neighboring upstream-side portion of a flow channel and a downstream-side portion of the flow channel, a gas diffusion layer touching at least a ridge between an upstream region of the flow channel on the upstream side and a downstream region of the flow channel on the downstream side, has a lower porosity than the gas diffusion layer touching other ridges and touching the flow channels.

### BACKGROUND OF THE INVENTION

1. Field of the Invention

The present invention relates to fuel cells using an electrochemical reaction, and in particular, to the prevention of slippage of gas flowing in flow paths.

2. Description of the Related Art

In general, fuel cells comprise: an electrochemical electro-chemical electricity-generating element that sandwiches and holds an ion-conducting electrolyte membrane, via porous catalytic layers, between a fuel electrode and an oxidizing electrode that include the catalytic layers and porous gas diffusion layers; a first separator plate, disposed on one side of the electrochemical electricity-generating element, on which is arranged a fuel gas flow path for supplying fuel gas for the fuel electrode, and a second separator plate, disposed on the other side of the electrochemical electricity-generating element, on which is arranged an oxidizing gas flow path for supplying oxidizing gas for the oxidizing electrode.

In this type of fuel cell, the gas diffusion layers smoothly transfer reaction gases (the fuel gas and the oxidizing gas) from the gas flow paths to the catalytic layers, and while having a function to discharge reaction-generated products, such as generated gas and water, to the gas flow paths, at the same time form slippage paths for the reaction gases, when the cell is viewed on the flat, causing a decrease in gas usage efficiency.

Conventional fuel cells, for example as disclosed in Japanese Laid-Open Patent Publication 2001-76746 (page 3, FIG. 1), comprise single cells in which an electrolyte membrane is sandwiched and held by the fuel electrode and the oxidizing electrode, and separator plates on which a parallel fuel flow-channel group, formed of a plurality of parallel channels, supplies fuel gas to the fuel electrode, and on which a parallel oxidizing flow-channel group, formed of a plurality of parallel channels, supplies oxidizing gas to the oxidizing electrode, each of the flow-channel groups running in bends, and the cells and the separator plates being sequentially built up to form a laminated body. In this type of fuel cell, the ridge width between adjacent parallel flow-channel groups is made larger than the ridge width between the channels within the parallel flow-channel groups, so that gas short-cutting within the separator flow paths is reduced.

However, in the above described conventional fuel cells, while it is possible to reduce gas slippage within the gas diffusion layers by regulating the inter-channel distances (the ridge widths), it cannot be completely prevented; furthermore, when the ridge widths are made extremely wide for the purpose of avoiding gas slippage as much as possible, there has been a problem in that it becomes difficult to diffuse the reaction gas to the catalytic layers in these regions, and the reaction face of the electrodes does not function effectively.

### SUMMARY OF THE INVENTION

The present invention is directed at solving the problems of the conventional fuel cells as described above, and has as an object the provision of a fuel cell that can prevent gas slippage with minimal reduction of effective area for electrode reaction.

The fuel cell related to the present invention includes: an electrochemical electricity-generating element that sandwiches and holds an ion-conducting electrolyte membrane, via catalytic layers, between a fuel electrode that includes a porous catalytic layer and a porous gas diffusion layer and an oxidizing electrode that includes a porous catalytic layer and a porous gas diffusion layer; a first separator plate, disposed on one side of the electrochemical electricity-generating element, on which is arranged a fuel gas flow path for supplying fuel gas for the fuel electrode, and a second separator plate, disposed on the other side of the electrochemical electricity-generating element, on which is arranged an oxidizing gas flow path for supplying oxidizing gas for the oxidizing electrode. At least one of either the fuel gas flow path or the oxidizing gas flow path is configured so that the gas flows from one end of the flow channel, which runs in bends, to the other, and, among ridges between neighboring upstream-side channel portions and downstream-side channel portions, the porosity of the gas diffusion layer where it touches at least a ridge between an upstream region of an upstream-side flow channel portion and a downstream region of a downstream-side flow channel portion is lower than the porosity of the gas diffusion layer touching other ridges and the fluid diffusion layer touching the flow channels.

Furthermore, at least one of either the fuel gas flow path or the oxidizing gas flow path has a plurality of flow channel groups configured as a plurality of flow channels and a gas supply manifold and a gas discharge manifold to which these flow channels commonly communicate, and these are configured to have the gas in neighboring flow channel groups flowing in reverse directions so that, among the ridges between neighboring flow channel groups, the porosity of the gas diffusion layer touching at least one ridge between an upstream portion of the flow channels and a downstream portion of the flow channels is lower than the porosity of the gas diffusion layer touching other ridges and the gas diffusion layer touching the flow channels.

Furthermore, at least one of either the fuel gas flow path or the oxidizing gas flow path has a plurality of flow channel groups configured as flow channels that run in bends, with a gas supply manifold and a gas discharge manifold to which these flow channels commonly communicate, and these are configured to have the gas in neighboring flow channel groups flowing in the same direction, so that the porosity of the gas diffusion layer touching the ridge between neighboring flow channel groups is lower than the porosity of the gas diffusion layer touching other ridges and the gas diffusion layer touching the flow channels.

### BRIEF DESCRIPTION OF THE DRAWINGS

A preferred embodiment of the present invention will be described in detail with reference to the following figures, wherein:

FIG. 1 is an explanatory sectional view of a fuel cell according to Embodiment 1 of the present invention and illustrates the simulated appearance of the main members of the fuel cell cut along its stack layers;

FIG. 2 is an explanatory plan view of the fuel cell according to Embodiment 1 of the present invention and illustrates an anode gas diffusion layer and an anode-side separator plate viewed from an anode catalytic layer side;

FIG. 3 is a plan view illustrating an enlargement of a portion of FIG. 2;

FIG. 4 is an explanatory plan view of the fuel cell according to Embodiment 1 of the present invention and illustrates the anode gas diffusion layer and the anode-side separator plate viewed from the anode catalytic layer side;

FIG. 5 is an explanatory plan view of the fuel cell according to Embodiment 2 of the present invention and illustrates the anode gas diffusion layer and the anode-side separator plate viewed from the anode catalytic layer side;

FIG. 6 is an explanatory plan view of the fuel cell according to Embodiment 3 of the present invention and illustrates the anode gas diffusion layer and the anode-side separator plate viewed from the anode catalytic layer side;

FIG. 7 is an explanatory sectional view of the fuel cell according to Embodiment 4 of the present invention and illustrates the simulated appearance of the main members of the fuel cell cut along the stack layer; and

FIG. 8 is an explanatory sectional view of the fuel cell according to Embodiment 5 of the present invention and illustrates the simulated appearance of the main members of the fuel cell cut along the stack layer.

### DETAILED DESCRIPTION OF THE PREFERRED EMBODIMENTS

### Embodiment 1

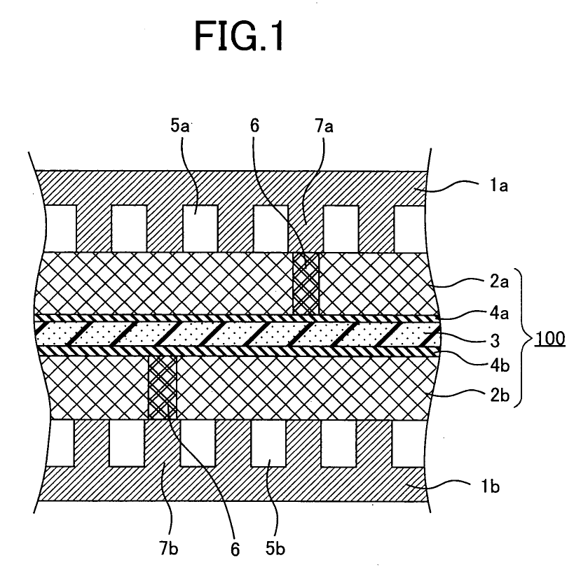

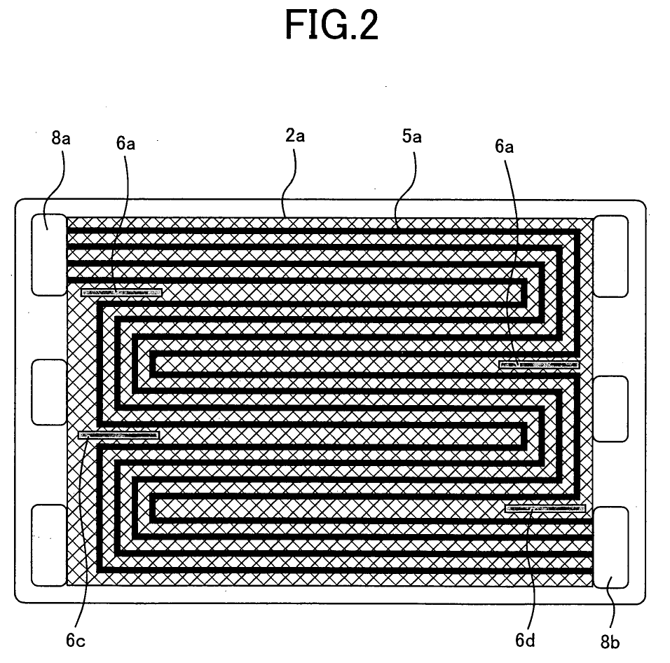

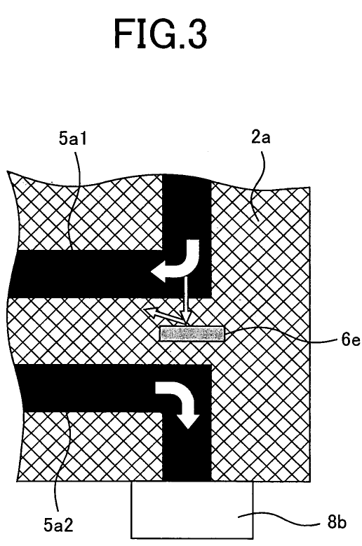

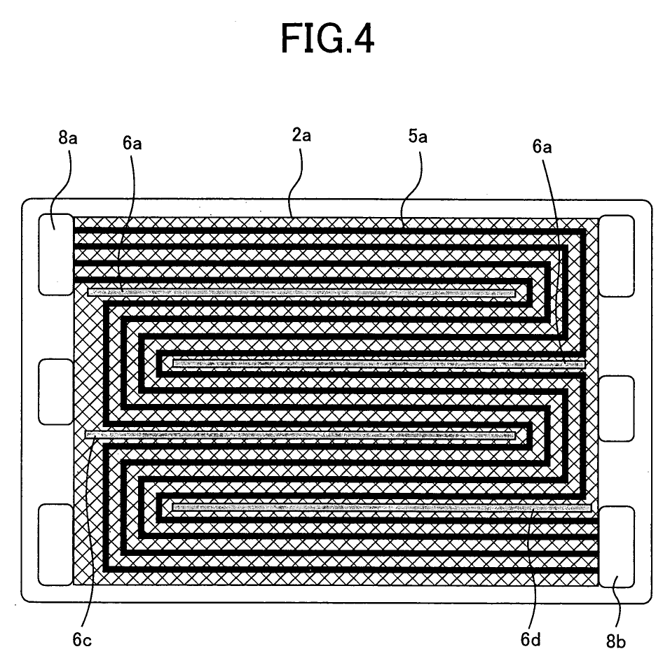

FIG. 1 FIG. 4 are explanatory views of a fuel cell according to Embodiment 1 of the present invention, and more specifically, FIG. 1 is a sectional view illustrating the simulated appearance of the main members of the fuel cell cut along its stack-layer direction, FIG. 2 is a plan view of an anode gas diffusion layer and an anode-side separator viewed from an anode catalytic layer side, FIG. 3 is a plan view illustrating an enlargement of a portion of FIG. 2, and FIG. 4 is a plan view of the anode gas diffusion layer and the anode-side separator viewed from the anode catalytic layer side.

As illustrated in FIG. 1, the present embodiment is configured as a seven-layered laminated structure unit built up of, in order, an anode-side (fuel electrode side) separator plate la, an anode gas diffusion layer 2a, an anode catalytic layer 4a, a proton-exchange electrolyte membrane 3, a cathode (oxidizing electrode) catalytic layer 4b, a cathode gas diffusion layer 2b and a cathode-side separator plate 1b. That is, the embodiment is provided with: an electrochemical electricity-generating element 100 into which an ion-conducting electrolyte membrane 3 is sandwiched, via porous catalytic layers 4a and 4b, between a fuel electrode that includes the anode gas diffusion layer 2a, which is porous, and the anode catalytic layer 4a, and an oxidizing electrode that includes the cathode gas diffusion layer 2b, which is porous, and the cathode catalytic layer 4b; a first separator plate 1a disposed on the anode side of the electrochemical electricity-generating element 100, on which is arranged a fuel gas flow path for supplying fuel gas to the fuel electrode; and a second separator plate 1b disposed on the cathode side of the electrochemical electricity-generating element 100, on which is arranged an oxidizing gas flow path for supplying oxidizing gas to the oxidizing electrode.

In general, a material having no gas permeability while having high electrical conductivity, such as a metal plate whose surface is coated with carbon or precious metal plating, is used as the anode-side separator plate la and the cathode-side separator plate 1b material.

Furthermore, flow channels 5a, that are anode gas flow paths, are formed on the anode electrode side (the anode gas diffusion layer 2a side) face of the anode-side separator plate 1a, and on the face on the opposing side, coolant water flow paths, which are not illustrated, are formed. Furthermore, flow channels 5b, that are cathode gas flow paths, are formed on the cathode electrode side (the cathode gas diffusion layer 2b side) face of the cathode-side separator plate 1b, and on the face on the opposing side, coolant water flow paths, which are not illustrated, are formed. Ridges 7a are disposed between neighboring flow channels 5a on the anode-side separator plate 1a, and ridges 7b are disposed between neighboring flow channels 5b on the cathode-side separator plate 1b.

As an example, each of the flow channels, 5a and 5b, may have a height (depth) and width of the order of 1 mm, and each ridge, 7a and 7b, may have a width of the order of 1 mm.

One electricity generating unit, in which the anode side separator plate 1a and the cathode side separator plate 1b are disposed on either side of the electrochemical electricity-generating element 100, is illustrated in FIG. 1; however, in practice, fuel cells are often configured of a plurality of this type of unit in stacked layers. Additionally, the anode-side separator plate la and the cathode-side separator plate 1b need not be limited to being separate members, and a fuel cell layered stack may be configured using a consolidated type of separator plate where the fuel gas flow channels 5a are arranged on one of the main faces and the oxidizing gas flow channels 5b are arranged on the other of the main faces, and the fuel cell layered stack may be built up of alternate layers of this separator plate and the electrochemical electricity-generating element 100.

The gas diffusion layers 2a and 2b of the anode and the cathode are often formed of carbon, which has good electrical conductivity, such as carbon paper, carbon felt, carbon cloth, or the like, and a porous region having good permeability of the order of 60%˜90% is often used.

As an example, the thickness of each of the gas diffusion layer 2a and 2b may be of the order of 300 μm.

Carbon particles supported with platinum ruthenium alloy particles, are used in the anode-side catalytic layer 4a, and platinum micro-particles supported with carbon particles is used in the cathode-side catalytic layer 4b.

As an example, the thickness of each of the catalytic layers 4a and 4b may be of the order of 10 μm.

A proton-exchange electrolyte membrane 3 having proton conductivity is disposed between the anode catalytic layer 4a and the cathode catalytic layer 4b; this proton-exchange electrolyte membrane 3 isolates electrons and gas, while at the same time makes a connection for ions between the anode and the cathode.

As an example, the thickness of the proton-exchange electrolyte membrane 3 may be of the order of 50 μm.

As illustrated in FIG. 2, in the fuel cell in accordance with this embodiment at least one of either the fuel gas flow path or the oxidizing gas flow path (although FIG. 2 only shows the fuel gas flow path, both are present in this embodiment) has four flow channels 5a (illustrated by means of thick black lines in FIG. 2, and formed on the separator plate 1a below the gas diffusion layer 2a illustrated by means of hatching) that run in bends. Furthermore, at either end of each of the flow channels 5a, a gas supply manifold 8a (a fuel gas inlet manifold) and a gas discharge manifold 8b (a fuel gas outlet manifold), to which the four flow channels 5a collectively communicate, are provided, and the configuration is such that gas flows from one end of the flow channels 5a to the other end.

In one of the flow channels 5a that runs in bends, for example, as in the fourth and fifth flow channel portion or in the eighth and ninth flow channel portion from the top in FIG. 2, along the ridges on the separator plate between an upstream flow channel portion on the upstream side and a downstream flow channel portion on the downstream side, resin is impregnated into the pores of the porous gas diffusion layer 2a touching each ridge, at least between an upstream flow channel portion on the upstream side and the downstream flow channel portion on the downstream side, so that its porosity is lower than the porosity of the gas diffusion layer 2a touching the other ridges or the gas diffusion layer touching the flow channels. In what follows, this type of low porosity region is referred to as a low porosity portion. In FIG. 1, this type of low porosity portion is disposed in four locations, 6a-6d.

The resin used is, for example, thermoplastic resin, and as long as the melting point is above the upper limit of the fuel cell operating temperature, any resin may be used. For example, in cases where the fuel cell is assumed to operate at 70° C., polyolefin resins, such as polyethylene (melting point 120° C.˜130° C.), polypropylene (melting point 160° C.˜170° C.), or the like, are preferable.

In cases of polyethylene impregnation, polyethylene cut in rectangular shapes, linear shapes, or islet shapes is disposed and temporarily retained at required points in the gas diffusion layer, the temperature is raised to 160° C., and it is inserted under pressure (for example, by a hot press). With polypropylene, it is preferable to insert under pressure at between 180° C. and 200° C. From the aspect of productivity, it is preferable to carry out the filling at temperatures higher than the melting point.

It is preferable to impregnate a volume such that the impregnating resin volume completely fills the holes of the porous region so that the porosity becomes zero. However, since the gas diffusion layer is compressed according to the surface pressure for securing the fuel cell during operation, the impregnation is carried out after calculating the decrease in empty-hole volume at this time. If the impregnation resin volume exceeds 100% of the porosity (if the volume to completely fill the holes of the porous region is exceeded), the ridges of the separator plates end up supporting the resin, and even if the surface pressure on the cell surfaces is uniform, this is not preferable.

Since there is a pressure difference in the gas flowing in the flow channels between the neighboring flow channel portion on the upstream side and the flow channel portion on the downstream side, the gas flowing in the flow channels on the upstream side diffuses (slips) through the gas diffusion layer touching the ridges between the flow channel portion on the upstream side and the flow channel portion on the downstream side, and bypasses the flow channel portion on the downstream side. In particular, since the gas pressure difference between the upstream region in the flow channel portion on the upstream side and the downstream region in the flow channel portion on the downstream side is large, this type of gas slippage can easily occur.

As a countermeasure, in this embodiment, in the gas diffusion layer 2a where it touches the ridges 7a between the upstream region of the flow channel on the upstream side and the downstream region of the flow channel on the downstream side, because the porosity of the region in which the holes are impregnated with resin is low compared to other regions, these types of low porosity portions 6a˜6d form a barrier wall for the diffusing gas and it is possible to prevent the above described type of gas slippage.

The impregnated resin forming a barrier wall for the gas and inhibiting gas slippage has merits in that operation with high gas usage rates is possible, but on the other hand demerits can be presumed in that, due to the catalytic layer 4a being covered and concealed by the impregnated resin, gas diffusion distance becomes longer, and as a result the effective electrode area decreases.

Thus, as illustrated in FIG. 2, among the ridges between the flow channel portions on the upstream side and flow channel portions on the downstream side, by filling with resin only the gas diffusion layers touching the ridges between the upstream portion of the flow channels on the upstream side and the downstream portion of the flow channels on the downstream side, where gas slippage occurs particularly easily, and by making only this region the low porosity region 6a˜6d, it is possible to effectively prevent the gas slippage in the region where the gas slippage occurs particularly easily, and gas slippage can be prevented with minimal reduction in the effective electrode reaction area.

Gas slippage occurs particularly easily in the same direction as the gas is flowing, so that, as illustrated in FIG. 3, it is preferable to arrange the resin-impregnated region (the low porosity portion 6e) within the gas diffusion layers touching the ridges between the upstream region of the flow channel portion 5a1 on the upstream side and the downstream region of the flow channel 5a2 on the downstream side, particularly near the bend in the upstream region of the flow channel portion 5a1 on the upstream side, that is, more precisely, at a position, where the gas flow is blocked, that is an extension of the gas flow direction where it is in the process of changing direction (the white arrows in FIG. 3) before it completely bends; and it is possible to prevent gas slippage with almost no reduction in the effective electrode area. Furthermore, where this scheme is adopted, in FIG. 2, since the flow channel portion on the upstream side does not bend, it is possible to omit the low porosity portion 6a.

In addition, since in this embodiment, a barrier wall for the gas diffusion is provided by impregnating resin into the holes of the porous region, by controlling the impregnated resin volume and making the porosity approximately zero, it is possible to obtain sufficient gas slippage prevention effects even where the barrier wall width is small. For example, in cases where the width of the ridges 7a is 1 mm, with the barrier wall having a width 1/10 of that—100 μm—the ability to prevent gas slippage has been confirmed. Thus, as illustrated in FIG. 4, by making the porosity of the gas diffusion layer touching the ridges between the flow channel portion on the upstream side and the flow channel portion on the downstream side lower than the porosity of the gas diffusion layer touching other ridges and the gas diffusion layers touching the flow channels, thus forming the low porosity portion 6, the gas slippage can be prevented with minimal reduction of the effective electrode reaction area.

Cases where the low porosity portions 6, 6a, and 6d are arranged at positions in the anode gas diffusion layer 2a and the cathode gas diffusion layer 2b, as illustrated in FIG. 4, are as in Embodiment 1; similarly, cases where the positions are as illustrated in FIG. 2 are as in Embodiment 2; cases where the low porosity region is not provided (the resin impregnation has not been carried out) are as in comparative example 1, wherein comparisons concerning gas slippage prevention effects are made using the gas usage ratio dependency characteristics for the cell voltage and the voltage variation range. Besides the usage rate, measurement conditions are made with a current density of 0.25 A/cm², a cell temperature of 80° C., a cathode humidification dew point of 75° C., an anode humidification dew point of 75° C.; a dummy gas consisting of a mixture of carbon dioxide and hydrogen, assuming methane reformed gas, is used as the fuel gas, and air is used as the oxidizing gas. In the above described electricity-generation test, a short stack built up of four single cell layers with an effective electrode area of 100 cm² is used. Coolant water flow paths are provided for each of the anode-side separator plates, and when generating electricity, water heated to 75° C. is passed through the coolant water flow paths at a flow speed of 100 ml/min/cell. Carbon paper with a porosity of 85% is used as the gas diffusion layers, a volume of polyethylene equal to approximately 100% of the hole volume of the impregnated area of the gas diffusion layers is used as the resin for slippage prevention.

Results are shown in tables 1˜3

TABLE 1

| | | | Comparison |
|---|---|---|---|
| | Embodiment 1 | Embodiment 2 | Example |
| 70% fuel usage rate | 0.73 V | 0.72 V | 0.72 V |
| 90% fuel usage rate | 0.70 V | 0.69 V | 0.67 V |

TABLE 2

| | | | Comparison |
|---|---|---|---|
| | Embodiment 1 | Embodiment 2 | Example |
| 40% oxygen usage rate | 0.73 V | 0.72 V | 0.72 V |
| 70% oxygen usage rate | 0.68 V | 0.70 V | 0.65 V |

TABLE 3

| | | | Comparison |
|---|---|---|---|
| | Embodiment 1 | Embodiment 2 | Example |
| Cell voltage | 0.70 V | 0.72 V | 0.67 V |
| Voltage variation range | ±5 mV | ±4 mV | ±18 mV |

As illustrated in Table 1, under high usage rate conditions of 90% fuel usage, the cell voltages in Embodiment 1 and Embodiment 2 rose to 0.70 V and 0.69 V, respectively, versus a cell voltage of 0.67 V in the comparison example.

However, with fuel gas including hydrogen that has fast gas diffusion speed, there was no problem with gas diffusion distances, and there was almost no difference between Embodiment 1 and Embodiment 2.

As illustrated in Table 2, under high usage rate conditions of 70% oxidizing (oxygen) usage, the cell voltages in Embodiment 1 and Embodiment 2 rose to 0.68 V and 0.70 V, respectively, versus a cell voltage of 0.65 V in the comparison example. In cases of cathode gas diffusion electrodes where the electrode reaction speed reached the gas diffusion rate limit, it was determined that Embodiment 2, in which the low porosity portions 6a-6d are set out in places, is more effective.

As illustrated in Table 3, under high usage rate conditions of 90% fuel usage, the cell voltages in Embodiment 1 and Embodiment 2 could be held down to within a low range of ±5 mV and ±4 mV, respectively, versus a voltage variation range of ±18 mV in the comparison example.

As explained above, in the present embodiment, by impregnating the holes of the porous regions with resin and lowering the porosity (making a low porosity portion), the gas slippage is prevented in the gas diffusion layer 2a, so that the porosity of the gas diffusion layer 2a can be controlled by the volume of resin impregnated. Thus, by making the porosity approximately zero, gas slippage can be completely stopped.

In this way, since the resin-impregnated region (the low porosity portion 6, 6a˜6e) forms a diffusion barrier wall for the gas diffusing through the gas diffusion layer 2a, the length of the low porosity portion 6a˜6e in the gas diffusion direction (the direction parallel to the contact face of the gas diffusion layer 2a with the catalytic layer 4a, that is, the direction perpendicular to the direction of the cell unit layers)—in other words, the width of the low porosity portion 6, 6a˜6e, may preferably be narrow, and in cases where it is sufficiently narrow compared to the ridges 7a, it is possible to obtain adequate slippage prevention effects.

Therefore, as illustrated in FIG. 4, even in cases where the low porosity portion extends in the direction of the gas flow over the whole of the ridges between the flow channel portion on the upstream side and the flow channel portion on the downstream side, the gas slippage can be prevented with minimal decrease in the effective electrode reaction area.

Further, as illustrated in FIG. 2 or FIG. 3, by arranging to limit the low porosity portions 6a˜6e to the regions where the gas pressure difference is large and the gas slippage occurs most easily, it is possible to effectively prevent the gas slippage in the regions where the gas slippage occurs most easily, and gas slippage can be prevented with minimal decrease in the effective electrode reaction area.

In the above explanation, the low porosity portions 6, 6a˜6e are arranged on either side of the anode gas diffusion layer 2a and the cathode gas diffusion layer 2b; however, the low porosity portions 6, 6a˜6e may be arranged on only one of either the anode or cathode gas diffusion layers. If the low porosity portions 6, 6a˜6e are arranged on the anode gas diffusion layer 2a, operation at high fuel usage rates becomes possible, and if the low porosity portions 6, 6a˜6e are arranged on the cathode gas diffusion layer 2b, operation at a high oxidizing usage rate becomes possible. While not specifically referred to in each of the embodiments below, the same situations apply.

Further, it is preferable that the impregnated location of the gas diffusion layers be in the regions touching the ridges of the separator plates and the location may jut out as far as the gas diffusion layers touching the flow channels.

In addition to providing the low porosity portions 6, 6a˜6e, the width of the separator plate ridge between the upstream-side flow channel portion on the upstream side and the downstream-side flow channel on the downstream side may be greater than the width of the other ridges. By controlling both the porosity and the ridge width in this way, the gas slippage can be prevented with greater confidence and with minimal decrease in effective electrode reaction area.

FIG. 2 and FIG. 4 illustrate cases in which four flow channels 5a run in bends, and a gas supply manifold 8a and a gas discharge manifold 8b are provided, with which the flow channels 5a commonly communicate; however, the number of flow channels is not limited to four, and there may be a plurality of flow channels or only one.

### Embodiment 2

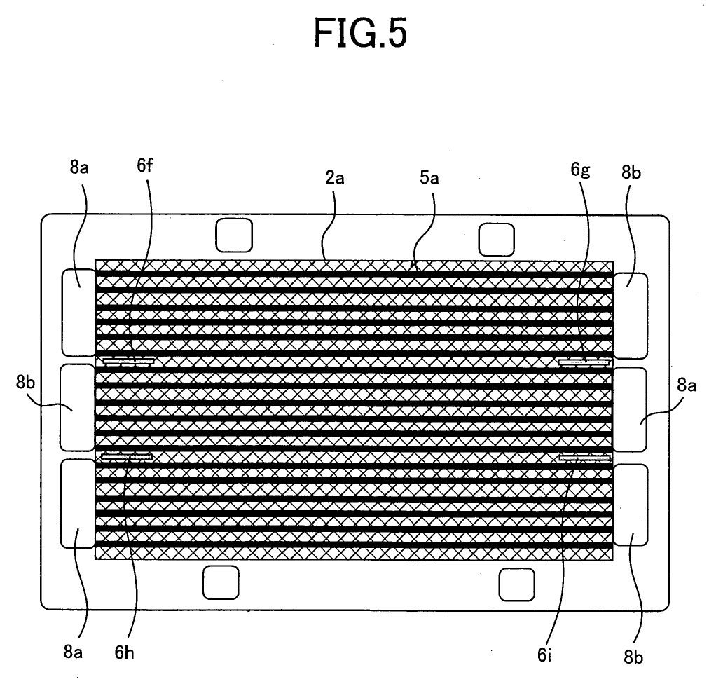

FIG. 5 is an explanatory plan view of the fuel cell according to Embodiment 2 of the present invention, and more specifically, illustrates the anode gas diffusion layer and the anode-side separator plate viewed from the anode catalytic layer side.

As illustrated in FIG. 5, the fuel cell according to this embodiment has a plurality of flow channel groups (there are three of them in FIG. 5) in which at least one of either the fuel gas flow path or the oxidizing gas flow path (in FIG. 5, the fuel gas flow path) is configured from a plurality of flow channels 5a (in FIG. 5, six flow channels), and a gas supply manifold (a fuel gas inlet manifold) 8a and a gas discharge manifold (a fuel gas outlet manifold) 8b with which the flow channels 5a commonly communicate, and it is configured so that the gas in neighboring flow channel groups flows in opposing directions.

Furthermore, among the ridges between the neighboring flow channel groups, resin is impregnated into the holes of the porous region in the gas diffusion layers touching the ridges between the upstream portion of one of the flow channel groups and the downstream portion of another of the flow channel groups, and its porosity is lower than the porosity of the gas diffusion layers touching the other ridges and the gas diffusion layers touching the flow channels. That is, it forms low porosity portions 6f˜6i.

The remainder of the configuration is similar to that of Embodiment 1, and the following explanations will focus mainly on points which are different from Embodiment 1

Since the gas in neighboring flow channel groups is flowing in opposing directions, the gas pressure difference is large between the neighboring flow channel groups (for example, in FIG. 5, between the sixth flow channel and the seventh flow channel from the top, or between the twelfth flow channel and the thirteenth flow channel from the top), and in particular, between the upstream portion of one of the flow channel groups and the downstream of the other of the flow channel groups; diffusion (slippage) occurs in the gas diffusion layers touching the ridges between the upstream portion of one of the flow channel groups and the downstream portion in the other of the flow channel groups, and the gas bypasses from the upstream portion of one of the flow channel groups to the downstream portion of the other of the flow channel groups. On this account, slippage of the gas that flows into the upstream portion of one of the flow channel groups from the gas inlet manifold 8a, occurs into the downstream portion of the other of the flow channel groups, and is discharged from the gas outlet manifold 8b of the other of the flow channel groups without contributing to the cell reaction.

Against this, in the present embodiment, the gas diffusion layers touching the ridge between the upstream of one of the flow channel groups and the downstream portion of the other of the flow channel groups form the low porosity portions 6f˜6i, and these low porosity portions 6f˜6i form a barrier wall to gas diffusion, and it is possible to prevent gas slippage as described above.

Thus, according to the present embodiment, it is possible to prevent gas slippage with minimal reduction in the effective electrode reaction area, similarly to the cases described above in Embodiment 1.

FIG. 5 illustrates cases where, among the ridges between the neighboring flow channel groups, only the gas diffusion layer touching the ridges between the upstream portion of one of the flow channel groups and the downstream portion of the other of the flow channel groups is made the low porosity portions 6f˜6i; however, similarly to cases in Embodiment 1, the low porosity portions may also extend in the gas flow direction over the complete gas diffusion layer touching the ridges between the neighboring flow channels.

In addition to providing the low porosity portions 6, 6f˜6i, the width of the separator plate ridges between the neighboring flow channels may be greater than the width of the other ridges. By controlling both the porosity and the ridge widths in this way, the gas slippage can be prevented with greater confidence and with minimal decrease in effective electrode reaction area.

Further, clearly the number of flow channels in one flow channel group and the number of channel groups is not limited to the cases illustrated in FIG. 5.

### Embodiment 3

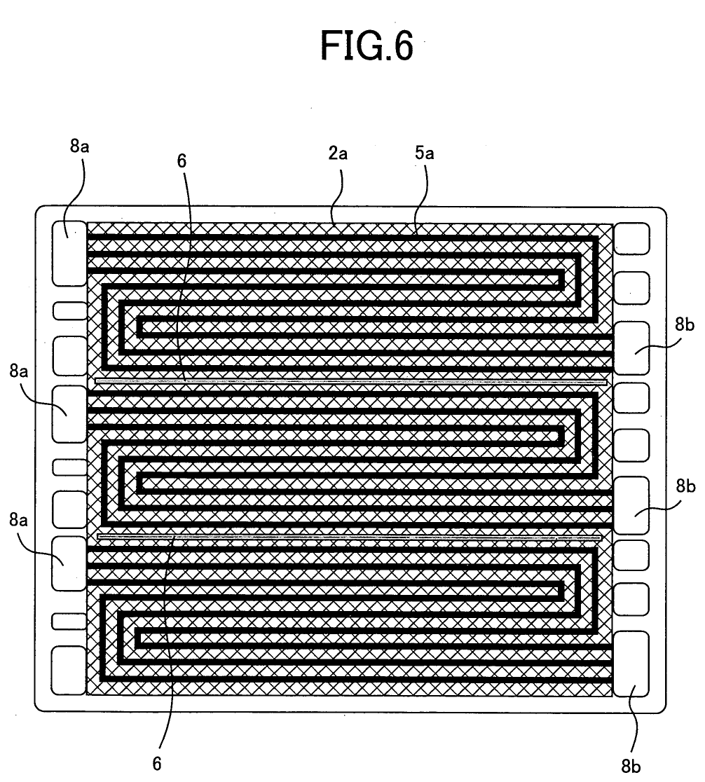

FIG. 6 is an explanatory plan view of the fuel cell according to Embodiment 3 of the present invention, and more specifically, illustrates the anode gas diffusion layer and the anode-side separator plate viewed from the anode catalytic layer side.

As illustrated in FIG. 6, the fuel cell according to this embodiment has a plurality of flow channel groups (there are three of them in FIG. 6) in which at least one of either the fuel gas flow path or the oxidizing gas flow path (although only the fuel gas flow path is illustrated in FIG. 6, both flow paths are present in this embodiment) is configured from the flow channels that run in bends (in FIG. 6, three flow channels) and a gas supply manifold (a fuel gas inlet manifold) 8a and a gas discharge manifold (a fuel gas outlet manifold) 8b with which the flow channels commonly communicate, and it is configured so that the gas in neighboring flow channel groups flows in similar directions.

Furthermore, resin is impregnated into the holes of the porous regions in the gas diffusion layers touching the ridges between neighboring flow channel groups, and its porosity is lower than the porosity of the gas diffusion layers touching the other ridges and the gas diffusion layers touching the flow channels. That is, it forms the low porosity portions 6.

The remainder of the configuration is similar to that of Embodiment 1, and the following explanations will focus mainly on points which are different from Embodiment 1

The gas in neighboring flow channel groups flows in the same directions; however, because the flow channel portion on the downstream side of one of the flow channel groups and the flow channel portion on the upstream side in the other of the flow channel groups are neighboring, the gas pressure difference between the neighboring flow channel groups is large, and the gas diffuses (slips) through the gas diffusion layer touching the ridges between the neighboring flow channel groups and bypasses from the upstream portion of one of the flow channel groups (the flow channel portion on the upstream side) to the downstream portion of the other of the flow channel groups (flow channel portion on the downstream side). On this account, slippage of the gas that flows into the upstream portion of one of the flow channel groups from the gas inlet manifold 8a, occurs into the downstream portion of the other of the flow channel groups, and is discharged from the gas outlet manifold 8b of the other of the flow channel groups with little contribution to the cell reaction.

Against this, in the present embodiment, the gas diffusion layer touching the ridges between the neighboring flow channel groups has the low porosity portions 6, and these low porosity portions 6 form a barrier wall to gas diffusion, and it is possible to prevent gas slippage as described above.

As has been explained in Embodiment 1, the width of the low porosity portion 6 may be narrow and in cases where it is sufficiently narrow compared to the ridge width, it is also possible to achieve slippage prevention effects. Therefore, as illustrated in FIG. 6, even in cases where the low porosity portion extends in the direction of the gas flow over the whole of the gas diffusion layer touching the ridges between the neighboring flow channel groups, the gas slippage can be prevented with minimal decrease in the effective electrode reaction area.

Furthermore, since in the present embodiment the flow channels 5a in each flow channel group run in bends, as in Embodiment 1, for example as illustrated by the broken line in FIG. 6, resin may be filled into the gas diffusion layers touching the ridges between the upstream regions on the upstream side of the flow channel regions and the downstream regions on the downstream side of the flow channel regions, so that these regions becomes the low porosity portions.

In addition to providing the low porosity portions 6, the width of the ridges between the neighboring flow channels may be greater than the width of the other ridges. By controlling both the porosity and the ridge widths in this way, the gas slippage can be prevented with greater confidence and with minimal decrease in effective electrode reaction area.

Further, clearly the number of flow channels in one flow channel group (there is no limitation to a plurality of flow channels; one flow channel is also possible), the number of bends in the flow channels, and the number of flow channel groups are not limited to the configuration illustrated in FIG. 6.

In each of the above described embodiments, the holes of the porous region are impregnated with resin to decrease the porosity of the gas diffusion layer so as to achieve the effect of preventing gas slippage; however, the impregnation material used to impregnate the holes of the porous region so as to decrease its porosity is not limited to resin, and liquids of low fluidity such as glass, oxides, carbon, etc., may also be used, the essential point being to have a material that is chemically and electrically stable in the fuel cell, and moreover a material in which physical movement of the gas can be controlled.

### Embodiment 4

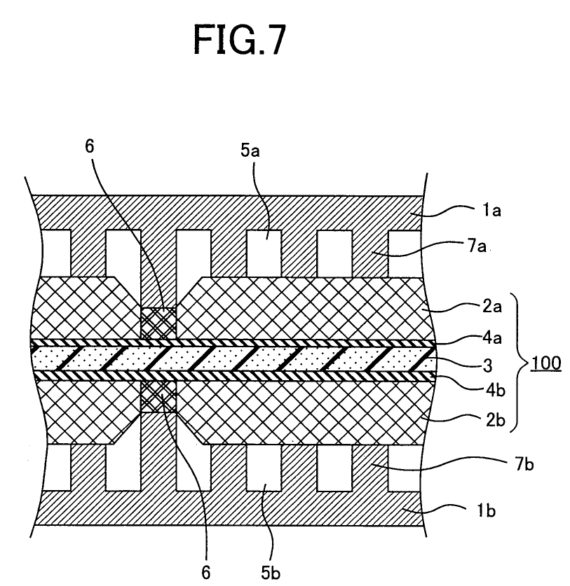

FIG. 7 is an explanatory sectional view of a fuel cell according to Embodiment 4 of the present invention, and more specifically, illustrates the simulated appearance of the main members of the fuel cell cut along the stack layer.

In each of the above described embodiments, the low porosity portion is configured by impregnating resin into the holes of the porous region of the gas diffusion layer; in the present embodiment, however, the low porosity portion is configured by compressing the gas diffusion layer in places. The remainder of the configuration is similar to each of the above embodiments, and the following explanations will focus mainly on the configuration of the low porosity portion.

As illustrated in FIG. 7, by means of a ridge portion 70a protruding higher than other portions of the ridges 7a on the anode side separator plate 1a, and a ridge portion 70b protruding higher than other portions of the ridges 7b on the opposing cathode side separator plate 1b, a low porosity portion 6 is formed that sandwiches and pressurizes the anode gas diffusion layer 2a, the anode catalytic layer 4a, the proton-exchange electrolyte membrane 3, the cathode catalytic layer 4b and the cathode gas diffusion layer 2b, so that the anode gas diffusion layer 2a and the cathode gas diffusion layer 2b, which can easily be elastically deformed relatively, are compressed and the porosity is decreased.

In this way, in cases where the porosity is decreased by compressing the gas diffusion layer in places, it is also possible to control the porosity by controlling the compressed volume of the gas diffusion layers (the height of the ridges 7a and 7b). Thus, by making the porosity approximately zero, gas slippage can be completely stopped.

### Embodiment 5

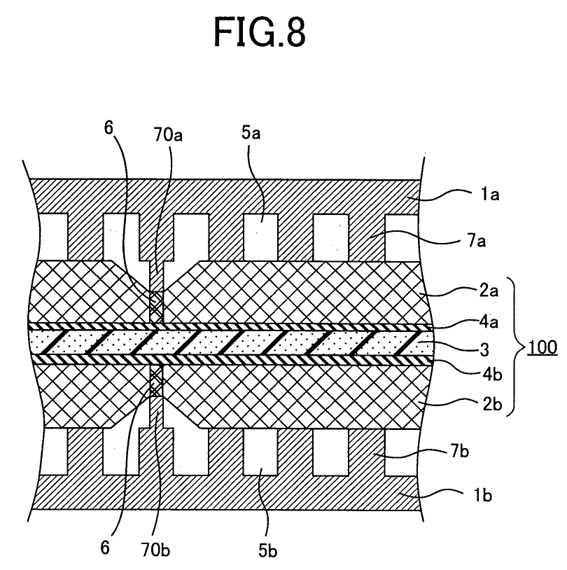

FIG. 8 is an explanatory sectional view of a fuel cell according to Embodiment 5 of the present invention, and more specifically, illustrates the simulated appearance of the main members of the fuel cell cut along the stack layer.

In the above described Embodiment 4, the widths of the protruding ridge portions 70a and 70b are the same as the widths of the other ridges 7a and 7b; in the present embodiment, however, the width of the portions 70a and 70b that protrude higher than the other ridges is narrow. (This portion may be referred to as the protruding portion below.)

For example, in order to compress 80% porous carbon paper so that it has a porosity of 0%, its thickness must be reduced to 20%. In reality, the compressed region of the gas diffusion layer (low porosity portion) is, for example, of the order of a few percent of the electrode reaction area, and even if the pressure exerted between the anode side separator plate 1a and the cathode side separator plate 1b is small, it is possible to compress the region sandwiched between the protruding portions of the gas diffusion layers.

Furthermore, in the present embodiment, by making the width of the protruding portion narrow, a large pressure is exerted in the protruding portion, so that even where the pressure exerted between the anode side separator plate 1a and the cathode side separator plate 1b is made smaller; the region sandwiched between the protruding portions of the gas diffusion layers can be compressed, and the path along which the gas slippage occurs can be cut off.

Considering possible damage to the proton-exchange electrolyte membrane 3 and the catalytic layers 4a and 4b, it is preferable to make the configuration with as low a pressure as possible.

Furthermore, as mentioned in Embodiment 1, the compressed region of the gas diffusion layer (the low porosity portion 6) has merits in that it forms a gas barrier wall to prevent gas slippage so that operation at high gas usage rates is possible, but on the other hand demerits are presumed in that the distance for gas diffused to the region of the catalytic layer facing the compressed region of the gas diffusion layer (the low porosity portion 6) becomes long, and as a result the effective electrode area decreases.

Thus, in the present embodiment, by making the width of the protruding portions narrow and by narrowing the area of the low porosity portion 6, gas slippage can be prevented with almost no decrease in the effective electrode reaction area.

In the above described embodiments, cases where the porosity of the low porosity portion 6, 6a˜6e is approximately 0% have been outlined; however, clearly there is no limitation to 0%.

In each of the above embodiments of the present invention, explanations have been given for cases applied to proton-exchange membrane fuel cells; however, the explanations may also be applied to phosphoric acid fuel cells.

In the present invention, gas slippage in regions where gas slippage can easily occur can be effectively prevented, and gas slippage can be stopped with minimal decrease in the effective electrode reaction area.

Further, the invention is not limited to the embodiments described above, and changes may be freely made within the spirit and scope of the invention.

1. A fuel cell comprising:
an electrochemical electricity-generating element including an ion-conducting electrolyte membrane sandwiched, via porous catalytic layers, between a fuel electrode that includes a fluid diffusion layer made of a porous material, and one of said catalytic layers, and an oxidizing electrode that includes a fluid diffusion layer made of a porous material, and another of said catalytic layers;
a first separator plate, disposed on a first side of the electrochemical electricity-generating element, on which is arranged a fuel fluid flow path for supplying fuel fluid for the fuel electrode; and
a second separator plate, disposed on a second side of the electrochemical electricity-generating element, on which is arranged an oxidizing fluid flow path for supplying oxidizing fluid for the oxidizing electrode, wherein at least one of the fuel fluid flow path and the oxidizing fluid flow path is configured so that the fluid flows from a first end of a flow channel, that includes bends, to a second end of the flow channel, and, among ridges between neighboring upstream-side channel portions and downstream-side channel portions, the fluid diffusion layer has a lower porosity where the fluid diffusion layer touches a ridge, at least between an upstream region of an upstream-side flow channel portion and a downstream region of a downstream-side flow channel portion, than where the fluid diffusion layer touches other ridges and where the fluid diffusion layer touches the flow channel.

2. The fuel cell as set forth in claim 1, wherein the porous material of the fluid diffusion layer includes holes where the porous material has the lower porosity and the holes are impregnated with resin.

3. The fuel cell as set forth in claim 1, wherein the ridge touching the fluid diffusion layer, where the fluid diffusion layer has the lower porosity has a height higher than other ridges that touch the fluid diffusion layer.

4. A fuel cell comprising:
an electrochemical electricity-generating element including an ion-conducting electrolyte membrane sandwiched, via porous catalytic layers, between a fuel electrode that includes a fluid diffusion layer made of a porous material, and one of said catalytic layers, and an oxidizing electrode that includes a fluid diffusion layer made of a porous material, and another of said catalytic layers; a first separator plate, disposed on a first side of the electrochemical electricity-generating element, on which is arranged a fuel fluid flow path for supplying fuel fluid for the fuel electrode; and
a second separator plate, disposed on a second side of the electrochemical electricity-generating element, on which is arranged an oxidizing fluid flow path for supplying oxidizing fluid for the oxidizing electrode, wherein at least one of the fuel fluid flow path and the oxidizing fluid flow path has a plurality of flow channel groups, configured as a plurality of flow channels, and a fluid supply manifold and a fluid discharge manifold with which the flow channels commonly communicate, said flow path being configured so that the fluid in neighboring flow channel groups flows in opposite directions, and, among ridges between the neighboring flow channel groups, the fluid diffusion layer has a lower porosity where the fluid diffusion layer touches at least one ridge between an upstream portion of one of the flow channel groups and a downstream portion of another of the flow channel groups than where the fluid diffusion layer touches other ridges and where the fluid diffusion layer touches the flow channels.

5. The fuel cell as set forth in claim 4, wherein the porous material of the fluid diffusion layer includes holes where the porous material has the lower porosity and the holes are impregnated with resin.

6. The fuel cell as set forth in claim 4, wherein the ridge touching the fluid diffusion layer, where the fluid diffusion layer has the lower porosity, has a height higher than other ridges that touch the fluid diffusion layer.

7. A fuel cell comprising:
an electrochemical electricity-generating element including an ion-conducting electrolyte membrane sandwiched, via porous catalytic layers, between a fuel electrode that includes a fluid diffusion layer made of porous material, and one of said catalytic layers, and an oxidizing electrode that includes a fluid diffusion layer made of porous material, and another of said catalytic layers;
a first separator plate, disposed on a first side of the electrochemical electricity-generating element, on which is arranged a fuel fluid flow path for supplying fuel fluid for the fuel electrode; and
a second separator plate, disposed on a second side of the electrochemical electricity-generating element, on which is arranged an oxidizing fluid flow path for supplying oxidizing fluid for the oxidizing electrode, wherein at least one of the fuel fluid flow path and the oxidizing fluid flow path has a plurality of flow channel groups, configured as flow channels that include bends, and a fluid supply manifold and a fluid discharge manifold with which the flow channels communicate, said flow path being configured so that the fluid in neighboring flow channel groups flows in the same direction, and, among ridges between the neighboring flow channel groups, the fluid diffusion layer has a lower porosity where the fluid diffusion layer touches a ridge between the neighboring flow channel groups than where the fluid diffusion layer touches other ridges and where the fluid diffusion layer touches the flow channel.

8. The fuel cell as set forth in claim 7, wherein the porous material of the fluid diffusion layer has the lower porosity and the holes are impregnated with resin.

9. The fuel cell as set forth in claim 7, wherein the ridge touching the fluid diffusion layer, where the fluid diffusion layer has the lower porosity has a height higher than other ridges that touch the fluid diffusion layer.
